(19) United States
(12) Patent Application Publication
(10) Pub. No.: US 2019/0213667 A1
(43) Pub. Date: Jul. 11, 2019

(54) SYSTEM FOR MANAGING A FLEET OF DEALERSHIP COURTESY VEHICLES

(71) Applicant: CMT Group LLC, Cleveland Heights, OH (US)

(72) Inventors: Trevor GILE, Chagrin Falls, OH (US); Kenneth MINARDO, Mayfield Heights, OH (US); Keith GARRY, Richmond Heights, OH (US)

(21) Appl. No.: 16/212,508

(22) Filed: Dec. 6, 2018

Related U.S. Application Data
(63) Continuation-in-part of application No. 15/698,234, filed on Sep. 7, 2017.
Application No. 15/698,234 is a continuation-in-part of application No. 15/801,407, filed on Nov. 2, 2017.
(60) Provisional application No. 62/384,528, filed on Sep. 7, 2016.
(60) Provisional application No. 62/416,381, filed on Nov. 2, 2016.

(51) Int. Cl. G06Q 30/06; G06Q 10/06

(52) U.S. Cl. CPC G06Q 30/0645; G06F 16/23; G06Q 10/06315

(57) ABSTRACT

Evaluating whether vehicles are to be added or removed from a dealership's courtesy vehicle fleet may include determining a difference between a number of vehicles in the fleet and a number of vehicles lent to determine a number of excess vehicles in the fleet, and outputting a removal instruction to a worker at the dealership indicating that the number of excess vehicles is to be removed from the fleet of courtesy vehicles. Evaluating when to remove vehicles from a dealership's courtesy vehicle fleet may include determining a time at which the vehicle's market value maximizes profit.

### BACKGROUND

Auto dealerships often provide courtesy vehicles to customers when, for example, a dealership is to perform maintenance or warranty repair work on a customer's own vehicle. Courtesy vehicles are sometimes referred to as “loaners.”

Larger dealerships may control relatively large fleets of courtesy vehicles, which presents a significant management challenge. The costs (e.g., ownership or lease, maintenance, etc.) of such fleets may erode the dealerships' profitability and/or consume outsized human and other resources.

These problems with dealerships' courtesy vehicle fleets are different from those of, for example, car rental companies. The business model for auto dealerships is different from that of car rental companies and, therefore, as described in detail below, not only are the problems different but solutions must also be different.

### SUMMARY OF THE INVENTION

The present disclosure provides methods and systems to address these problems. The main goal of these methods and systems is to reduce the size of the fleet to an ideal size that maximizes profit. The present disclosure discloses systems and methods for effectively and efficiently managing a fleet of courtesy vehicles at a dealership by evaluating fleet data and advisor data.

Fleet data may be useful when determining whether and when vehicles are to be added or removed from the fleet to attain an ideal fleet size. Evaluating whether vehicles are to be added or removed from a dealership's courtesy vehicle fleet may include determining a difference between a number of vehicles in the fleet and a number of vehicles lent to determine a number of excess vehicles in the fleet, and outputting a removal instruction to a worker at the dealership indicating that the number of excess vehicles is to be removed from the fleet of courtesy vehicles. Evaluating when to remove vehicles from a dealership's courtesy vehicle fleet may include determining a time at which the vehicle's market value maximizes profit.

Advisor data may be useful to manage advisors to ensure responsible lending of fleet vehicles and accountable management of the fleet.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

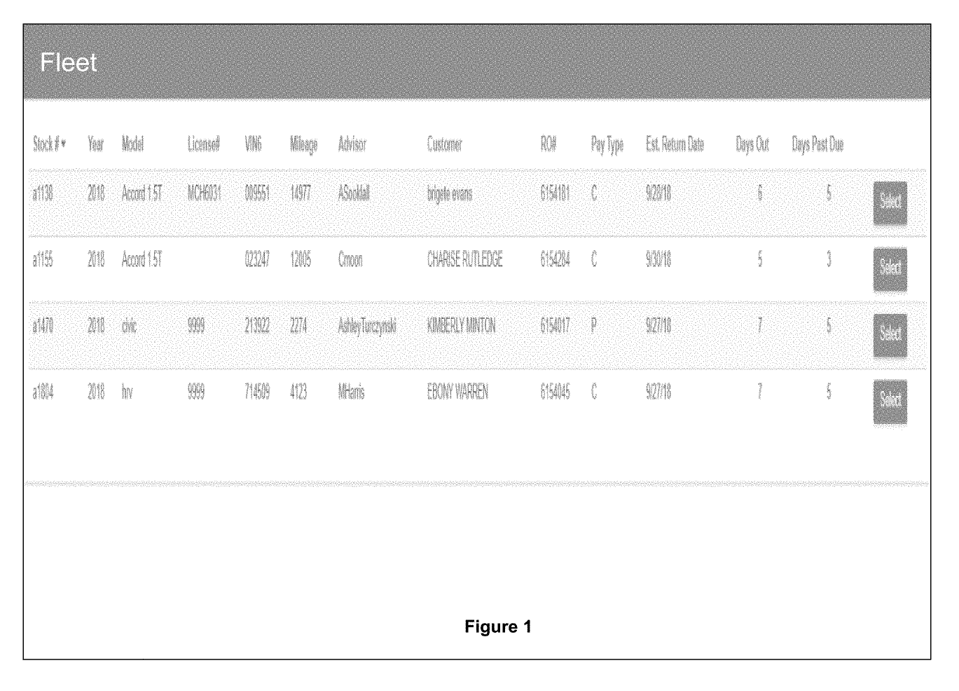

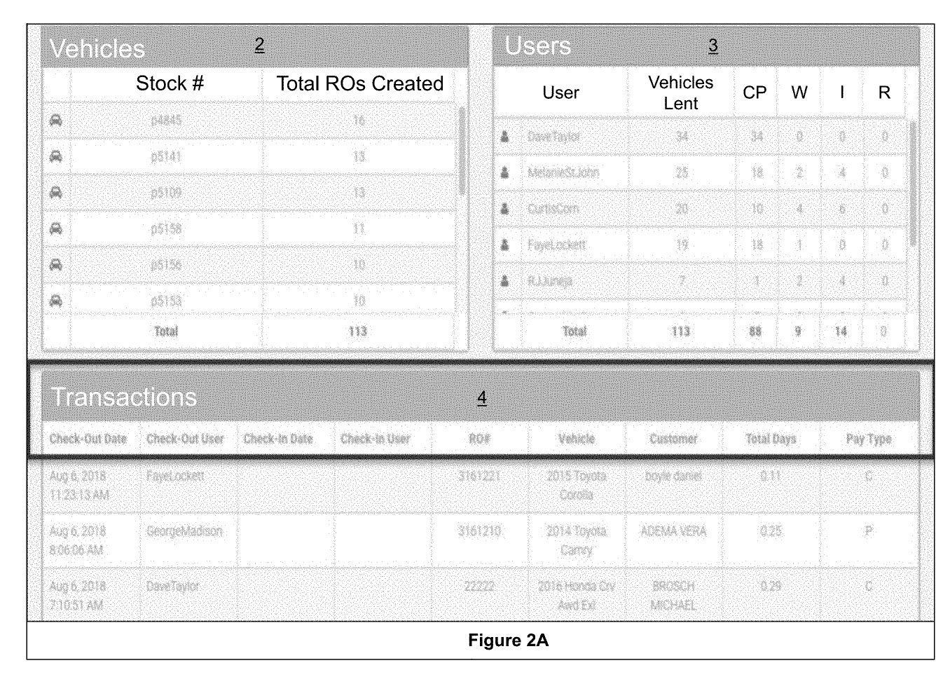

FIG. 1 illustrates a screenshot of an exemplary system for management of a fleet of courtesy vehicles at an auto dealership.

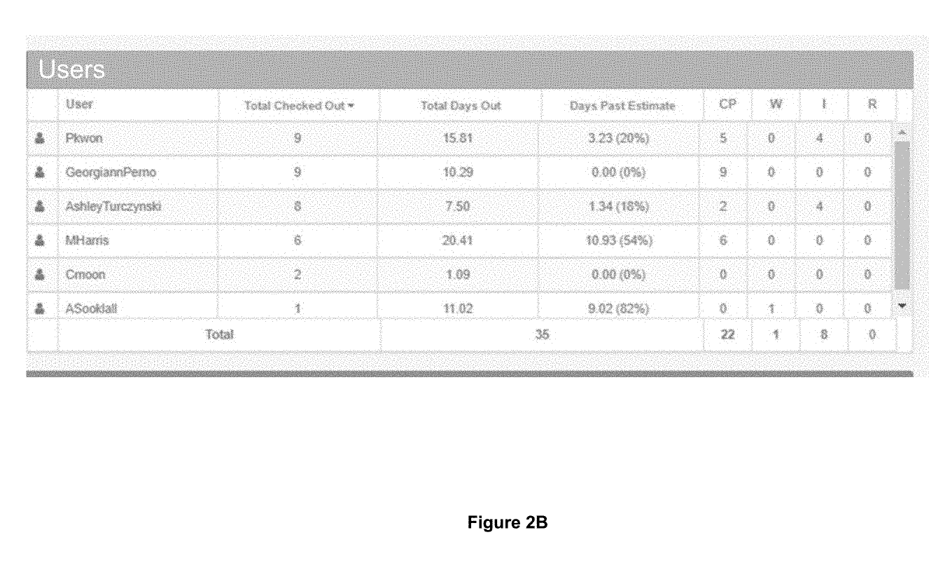

FIG. 2A illustrates another screenshot of the exemplary system for management of a fleet of courtesy vehicles at an auto dealership.

FIG. 2B illustrates another screenshot of the exemplary system for management of a fleet of courtesy vehicles at an auto dealership.

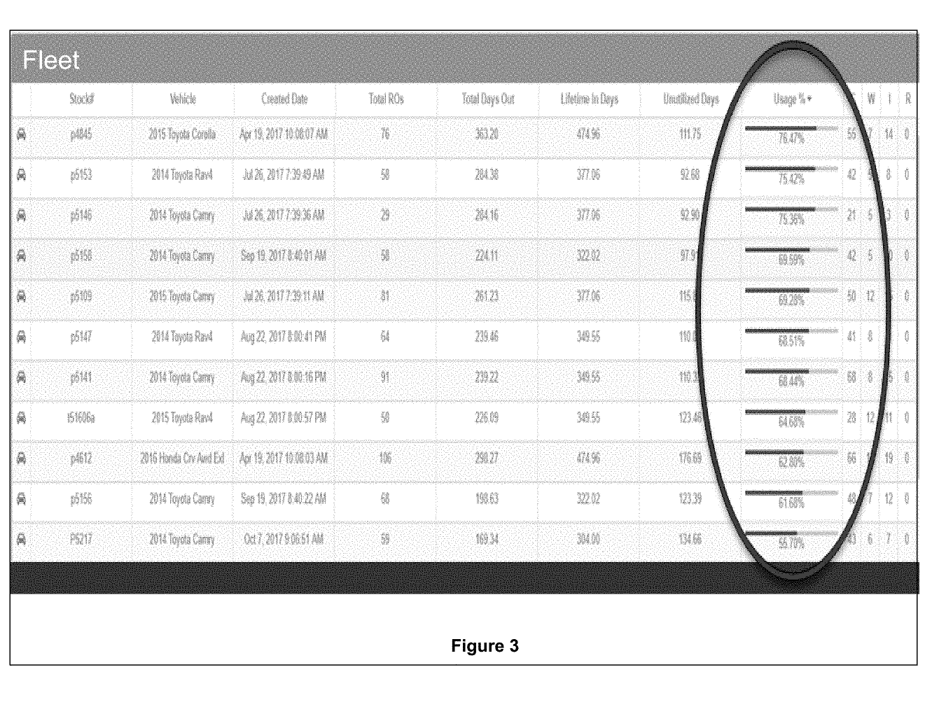

FIG. 3 illustrates another screenshot of the exemplary system for management of a fleet of courtesy vehicles at an auto dealership.

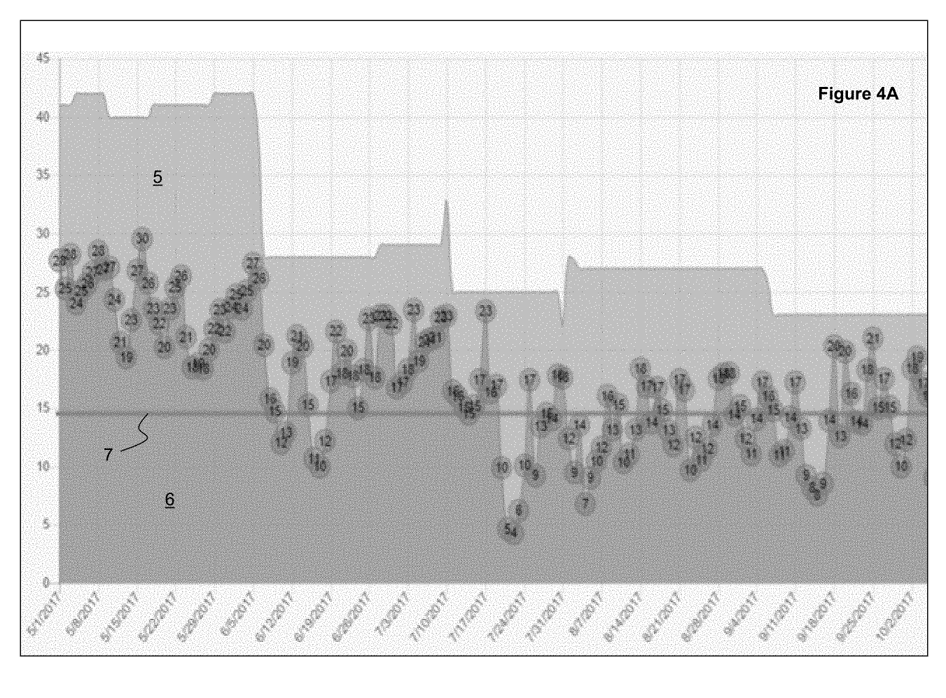

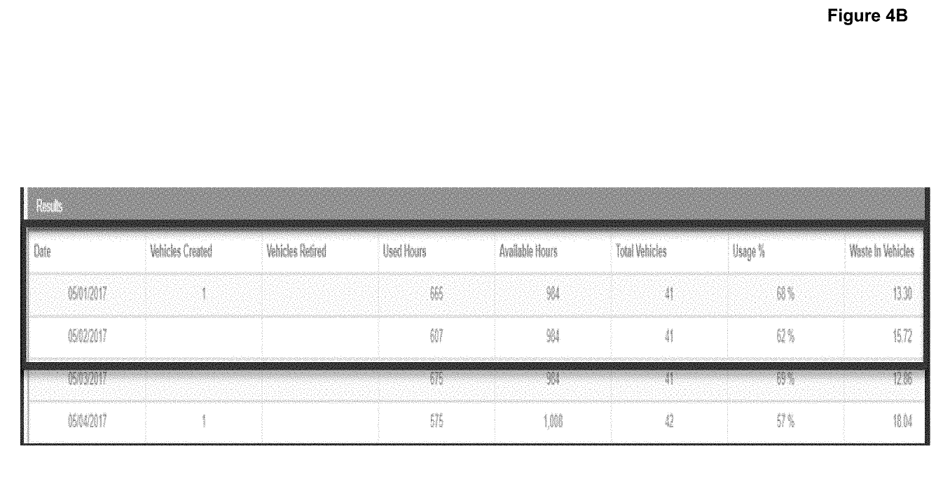

FIGS. 4A and 4B illustrate screenshots of the exemplary system for management of a fleet of courtesy vehicles at an auto dealership.

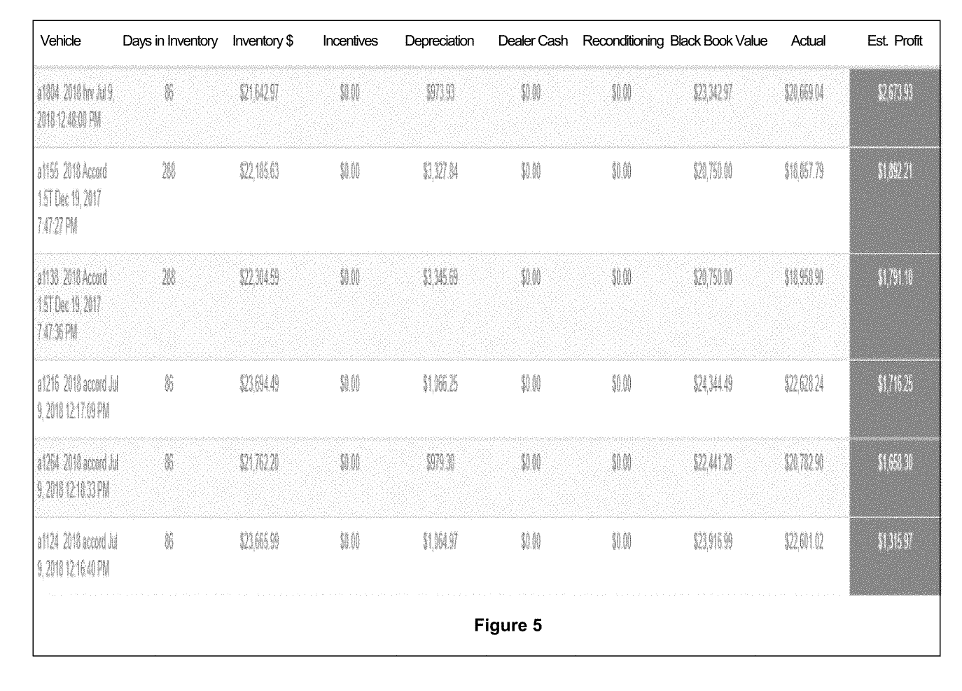

FIG. 5 illustrates another screenshot of the exemplary system for management of a fleet of courtesy vehicles at an auto dealership.

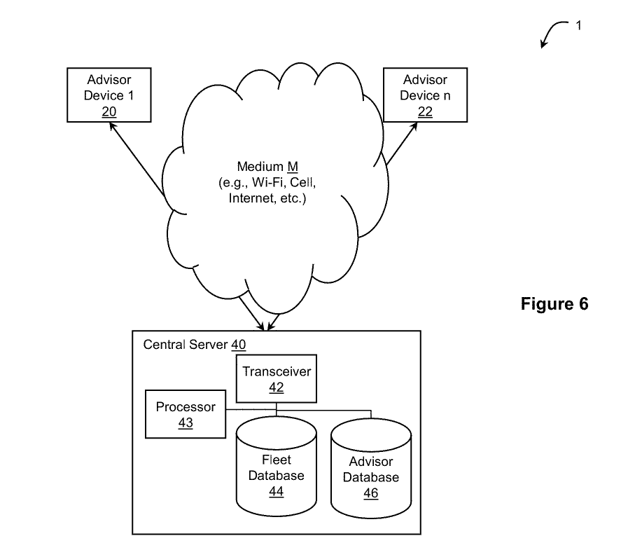

FIG. 6 illustrates a block diagram of an exemplary system for managing the size of a fleet of courtesy vehicles.

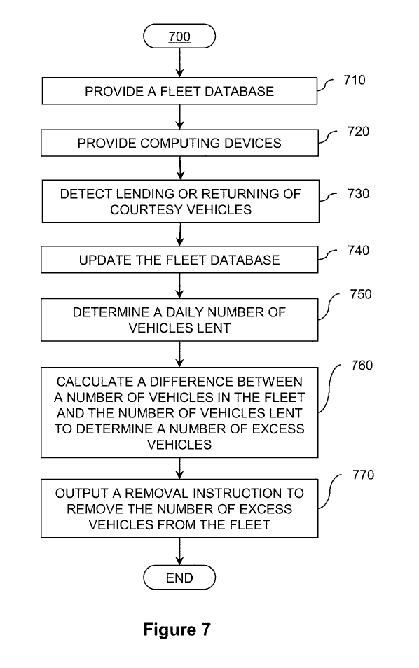

FIG. 7 illustrates a flow diagram for an exemplary method for evaluating whether vehicles are to be added or removed from a fleet of courtesy vehicles at a dealership.

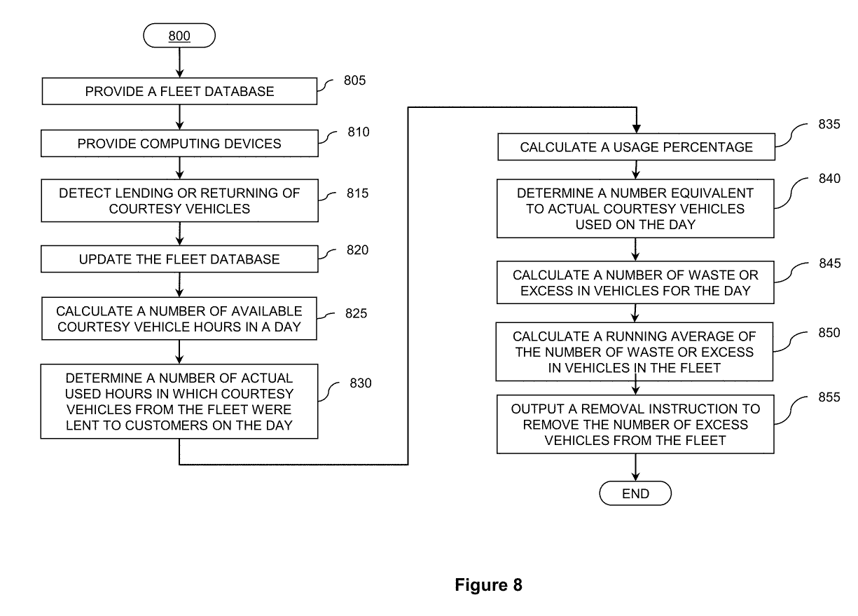

FIG. 8 illustrates a flow diagram for an exemplary method for evaluating whether vehicles are to be added or removed from a fleet of courtesy vehicles at a dealership.

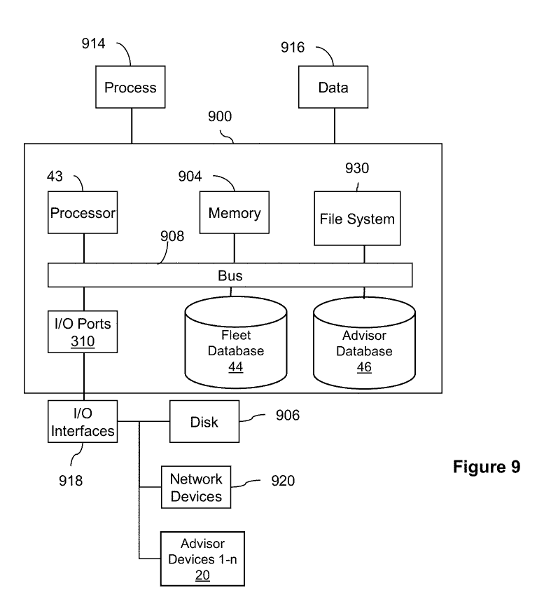

FIG. 9 illustrates a block diagram of an exemplary machine or apparatus for evaluating whether vehicles are to be added or removed from a fleet of courtesy vehicles at a dealership.

### DETAILED DESCRIPTION

FIG. 1 illustrates a screenshot of an exemplary system 1 for management of a fleet of courtesy vehicles at an auto dealership. As described below, the system 1 may include a fleet database that stores data associated with vehicles that form part of the dealership's fleet of courtesy vehicles. The system 1 updates the fleet database as necessary to reflect vehicles lent from the fleet and vehicles returned to the fleet such that the fleet database reflects the real-world status of the fleet. The fleet database may be a single, discrete database or it may be distributed among or make use of other new or preexisting databases such as customer relationship management (CRM) databases and document management system (DMS) databases the dealership may have access to.

The fleet database may include many fields including, as shown in FIG. 1, a stock number for each vehicle, the vehicle's make, model, year, license number, VIN number, and mileage. The database may also include information relating to transactions associated with specific vehicles at the dealership. For example, for each vehicle that is currently loaned, the database may include the name of an advisor at the dealership who lent the courtesy vehicle to the customer, the customer's name, a repair order (RO) number (a number that associates the courtesy vehicle to the customer's own vehicle being maintained or repaired), a pay type (whether the customer, the dealership, the manufacturer, etc. is paying for the courtesy vehicle), the estimated return date for the courtesy vehicle, how many days the courtesy vehicle has been out lent to the customer, how many days from the original days out estimate is the courtesy vehicle past due for return to the dealership, etc.

Fields from the fleet database may be displayed as shown in FIG. 1 to advisors, managers, etc. at the dealership. This information may be very useful in managing the courtesy vehicle fleet. The dealership may, for example, use past due information to contact a customer whose courtesy vehicle is past due to inquire as to any issues with the courtesy vehicle or otherwise inquire about when the customer expects to return the courtesy vehicle to the dealership.

FIG. 2A illustrates another screenshot of the exemplary system 1 for management of a fleet of courtesy vehicles at an auto dealership. The system 1 may store in the fleet database and may display at 2 a total number of repair orders (RO) associated with each vehicle (identified by its stock number).

The system 1 may also include a user or advisor database that stores data associated with users or advisors who lend courtesy vehicles from the fleet to customers. Like the fleet database, the advisor database may be a single database or it may be distributed among other new or preexisting databases such as the fleet database, a customer relationship management (CRM) database or a document management system (DMS) database. The advisor database may store, and thus the system 1 may display at 3, a number of courtesy vehicles lent by each user or advisor, a number of vehicles lent by each advisor by pay type (e.g., customer pay (CP), warranty (W), dealership (I), recall (R), etc.) amongst other user or advisor information.

The fleet database may further include data about every transaction in which a user or advisor lent a courtesy vehicle to a customer. The system 1 may display at 4 information about transactions. Transaction information may include the vehicle's check-out date and time, the name of the user or advisor who lent the vehicle to the customer, the vehicle's check-in (i.e., return) date and time, the name of the user or advisor who received the returned vehicle from the customer, the repair order (RO) number, a vehicle description (year, make, and model), the customer's name, the number of days the customer is expected to keep the vehicle, a pay type (e.g., customer, dealership, manufacturer, etc.)

FIG. 2B illustrates another screenshot of the exemplary system 1 for management of a fleet of courtesy vehicles at an auto dealership. As described above, the system 1 may include a user or advisor database that stores data associated with users or advisors who lend courtesy vehicles from the fleet to customers. The advisor database may store, and thus the system 1 may display a number of courtesy vehicles lent (checked out) by each user or advisor, the total number of days out (i.e., number of vehicles out x number of days each vehicle is out), a cumulative number of days past due (i.e., number of vehicles out x number of days each vehicle is past due), and a number of vehicles lent by each advisor by pay type (e.g., customer pay (CP), warranty (W), dealership (I), recall (R), etc.) amongst other user or advisor information. The dealership may use this information to manage advisors to ensure responsible lending (on average, less lending is better) of fleet vehicles and accountable management of the fleet by providing visibility on advisors' practices and hence encourage advisors to check on vehicles that are overdue, estimate lending time accurately, etc.

FIG. 3 illustrates another screenshot of the exemplary system 1 for management of a fleet of courtesy vehicles at an auto dealership. The system 1 may store in the fleet database and may display the date on which each vehicle was introduced to the fleet (Created Date in FIG. 3). From that date, the system 1 may calculate a lifetime in days of the vehicle as part of the fleet. The system 1 may also calculate, store in the fleet database and display the total number of days each vehicle is out (i.e., the days in its lifetime on the fleet that a vehicle has been lent to customers). The system 1 may then calculate and display the difference between the lifetime in the fleet in days and the total days out as unused days. The system 1 may also calculate and display a ratio of the total days out over the lifetime days as a usage percentage.

The usage percentage information may be very useful in managing the courtesy vehicle fleet. In general, fleet managers would aim to minimize disparities between vehicle's usage percentages. It could be, for example, that something is wrong mechanically, esthetically, odorously, or otherwise with a vehicle whose usage percentage is substantially lower than other vehicles in the fleet. It could be that a vehicle has a low usage percentage because it has been misplaced. The usage percentage information would be a very useful tool in pursuing the goal of minimizing disparities in vehicle's usage percentages by identifying vehicles in the fleet that may need attention.

FIGS. 4A and 4B illustrate other screenshots of the exemplary system 1 for management of a fleet of courtesy vehicles at an auto dealership.

As shown in FIG. 4A, based on information stored in the fleet database, the system 1 may calculate and display histograms (e.g., number of vehicles over time on a daily basis) of the number of vehicles on the fleet 5 and the number of vehicles out (i.e., vehicles lent to customers) 6. As may be appreciated from FIG. 4A, in this example, the number of vehicles in the fleet more often than not exceed the number of courtesy vehicles out with customers. In the context of dealerships' courtesy vehicle fleets this excess of courtesy vehicles is typically considered wasteful. The costs (e.g., ownership or lease, maintenance, etc.) of such excess vehicles in courtesy fleets erodes the dealerships' profitability and/or consume outsized human and other resources.

This is at least one respect in which the business model for dealerships in managing their courtesy vehicle fleets is different from that of car rental companies. Car rental companies generally cannot afford to run out of vehicles because they profit from the rental of vehicles; without vehicles there is no profit. Therefore, they typically must carry excess vehicles. Dealerships, on the other hand, typically profit from the sale or long-term lease of vehicles. Dealerships do not typically profit from short term lending of vehicles. In fact, dealerships typically lose from excess courtesy vehicles and therefore, in general, dealerships would rather be short a few courtesy vehicles than have a few in excess. In the case a dealership is short a courtesy vehicle, the dealership can always rent a vehicle short-term from a car rental company to provide to the customer in need of a courtesy vehicle. The cost of renting a vehicle for a short term to provide to the customer as a courtesy vehicle is typically lower than the costs related to an excess vehicle in the courtesy fleet.

In the illustrated embodiment of FIG. 4A, the system 1 determines, based on data obtained from the fleet database, a running average 7 of vehicles lent to customers. In one embodiment, the number of vehicles lent to customers may include vehicles from the fleet of courtesy vehicles and/or other vehicles such as vehicles rented from a car rental company. In the example of FIG. 4A, the running average has been determined at 15 vehicles lent on a daily basis. The system 1 may then calculate a difference between the number of courtesy vehicles in the fleet (about 23 on Oct. 2, 2017 in the example of FIG. 4A) and the number of vehicles lent on a daily basis or the running average of vehicles lent (15) to determine a number of excess vehicles in the fleet. The number of excess vehicles would be eight in the example of FIG. 4A. The system 1 may then output a removal instruction to a worker at the dealership indicating that the number of excess vehicles in the fleet of courtesy vehicles is to be removed or retired from the fleet of courtesy vehicles. In the example of FIG. 4A, the worker would remove eight vehicles from the fleet. Once the excess vehicles have been removed, the fleet database may be updated to reflect the actual number of courtesy vehicles in the fleet.

In another example (not shown) the system 1 may calculate the difference between the number of courtesy vehicles in the fleet and the running average of vehicles lent as a negative number (indicating that many vehicles have been rented from car rental companies) to determine a shortage number of vehicles in the fleet of courtesy vehicles. In such a case, the system 1 may output an addition instruction to a worker at the dealership indicating that the number of shortage vehicles in the fleet of courtesy vehicles is to be added to the fleet of courtesy vehicles. The worker would add the number of shortage courtesy vehicles to the fleet. Once the courtesy vehicles have been added, the fleet database may be updated to reflect the actual number of courtesy vehicles in the fleet.

The embodiment of FIG. 4B is similar. For any given day, the system 1 may calculate a number of available courtesy vehicle hours by multiplying the number of courtesy vehicles on the fleet by 24 hours in a day. In FIG. 4B, on May 1, 2017 there are 41 total courtesy vehicles in the fleet resulting in 984 available hours. The system 1 may also determine the number of actual used hours in which courtesy vehicles from the fleet were out with customers. In the example of FIG. 4B, the used hours for May 1, 2017 is 665 hours. By dividing the number of used hours (665) by the number of available hours (984) the system 1 may calculate a usage percentage (68% in FIG. 4B). The system 1 may then multiply the total number of vehicles (41) times the usage percentage (68%) to determine a number equivalent to actual vehicles used (27.70). The difference between the total number of courtesy vehicles in the fleet and the number equivalent to actual vehicles used (27.70) represents the waste or excess in vehicles (13.30) for this given day.

The system 1 may determine a running average of the waste or excess in vehicles. The system 1 may then, at periodic (e.g., daily, weekly, monthly, etc.) intervals, output removal instructions to a worker at the dealership indicating that the running average number of excess courtesy vehicles in the fleet is to be removed or retired. In the example of FIG. 4B, the worker may remove 13 vehicles from the fleet. Once the excess vehicles have been removed, the fleet database may be updated to reflect the actual number of courtesy vehicles in the fleet.

In this manner the size of the fleet may be effectively, efficiently, and profitably managed to an ideal size in the context of car dealerships' courtesy vehicles which, again, is often a different ideal size from that of a car rental company.

FIG. 5 illustrates another screenshot of the exemplary system 1 for management of a fleet of courtesy vehicles at an auto dealership. The system 1 may store in the fleet database and may display a vehicle description (e.g., stock number and date on which each vehicle was introduced to the fleet, etc.) From that information, the system 1 may calculate a lifetime in days of the vehicle as part of the fleet or days in inventory. The system 1 may also store in the fleet database and display a dollar amount the dealership invested in adding the vehicle to the fleet or inventory $, incentives (in dollars) given to the dealership when adding the vehicle to the fleet, depreciation of each vehicle (based on, for example, days in used, mileage, etc.), dealer cash (any additional money the dealership has invested in the vehicle), reconditioning (any money the dealership must spend in reconditioning the vehicle), etc. From this information the system 1 may calculate and display an estimated actual current dealership investment in each vehicle. The system 1 may also store in the fleet database and display the current black book value of the vehicle. The system 1 may then calculate the difference between the black book value of the vehicle and the estimated actual current dealership investment in each vehicle to determine an estimated profit if the vehicle was retired from the fleet and sold in the market.

The dealership may establish a threshold for estimated profit above (or below) which the dealership may retire a courtesy vehicle from the fleet to be sold in the market. For example, a dealership may establish a threshold of one dollar estimated profit (whenever the black book value exceeds the estimated actual current dealership investment in the vehicle) to retire a courtesy vehicle from the fleet to be sold in the market. In another example, a dealership may establish a threshold of $2,000 dollars estimated profit to retire a courtesy vehicle from the fleet to be sold in the market. In this exemplary established threshold, the first vehicle listed in FIG. 5 would exceed the $2,000 threshold. As a result, the system 1 may then output a removal instruction to a worker at the dealership indicating that this specific courtesy vehicle is to be retired from the fleet and sold in the market. The worker may remove the vehicle from the fleet. Once the vehicle has been removed, the fleet database may be updated to reflect the actual courtesy vehicles in the fleet.

In this additional manner the size of the fleet may be effectively, efficiently, and profitably managed to an ideal size in the context of car dealerships' courtesy vehicles.

FIG. 6 illustrates a block diagram of an exemplary system 1 for managing the size of a fleet of courtesy vehicles. The system 1 includes two major components: the advisor devices 20, 22 and the central server 40. FIG. 6 also shows the medium M through which the advisor devices 20, 22 and the central server 40 communicate with each other.

The advisor devices 20, 22 may correspond to computing devices such as PCs, tablets, notebooks, etc. Regarding data storage and distribution, the central server 40 may include a transceiver 42 (or discrete transmitter and receiver) that communicates with the advisor devices 20, 22. The central server 40 may also include a processor 43 programmed to perform at least some of the various steps and processes disclosed herein for managing the size of a fleet of courtesy vehicles. The advisor devices 20, 22 similarly include processors of their own that may be programmed to perform at least some of the various steps and processes disclosed herein for managing the size of a fleet of courtesy vehicles. The central server 40 may also include the fleet database 44 and the advisor database 46. The fleet database 44 and the advisor database 46 may be discrete databases or they may be combined or distributed among or make use of other new or preexisting databases such as customer relationship management (CRM) databases and document management system (DMS) databases the dealership may have access to. Also, the medium M may be any medium used to transmit data generally such as, for example, the Internet, satellite communication, Wi-Fi, etc.

The system 1 may be implemented using software, hardware, analog or digital techniques.

Exemplary methods may be better appreciated with reference to the flow diagrams of FIGS. 7 and 8. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an exemplary methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagrams illustrate functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

FIG. 7 illustrates a flow diagram for an exemplary method 700 for evaluating whether vehicles are to be added or removed from a fleet of courtesy vehicles at a dealership.

At 710, the method 700 provides a fleet database configured to store data associated with vehicles forming part of the fleet of courtesy vehicles. At 720, the method 700 provides at least one computing device including a programmable processor coupled to the fleet database. At 730, the method 700 detects, via the at least one computing device, at least one of lending or returning of at least one vehicle from the fleet of courtesy vehicles. At 740, the method 700 updates, via the at least one computing device and in response to the detected at least one of lending or returning of the at least one vehicle from the fleet of courtesy vehicles, the fleet database for the data to reflect vehicles lent. At 750, the method 700 determines, via the at least one computing device and based on the data obtained from the fleet database updated to reflect vehicles lent, a daily number or a running average of vehicles lent. At 760, the method 700 calculates, via the at least one computing device and in response to the determining the daily number or the running average of vehicles lent, a difference between a number of vehicles in the fleet of courtesy vehicles and the daily number or the running average of vehicles lent to determine a number of excess vehicles in the fleet of courtesy vehicles. At 770, the method 700 outputs, via the at least one computing device and in response to the calculating the difference between the number of vehicles in the fleet of courtesy vehicles and the daily number or the running average of vehicles lent to determine the number of excess vehicles in the fleet of courtesy vehicles, a removal instruction to a worker at the dealership indicating that the number of excess vehicles in the fleet of courtesy vehicles is to be removed from the fleet of courtesy vehicles.

FIG. 8 illustrates a flow diagram for an exemplary method 800 for evaluating whether vehicles are to be added or removed from a fleet of courtesy vehicles at a dealership.

The method 800 includes at 805 providing a fleet database configured to store data associated with vehicles forming part of the fleet of courtesy vehicles. At 810, the method 800 provides at least one computing device including a programmable processor coupled to the fleet database. At 815, the method 800 detects at least one of lending or returning of at least one vehicle. At 820, the method 800 updates, in response to the detected at least one of lending or returning of the at least one vehicle, the fleet database for the data to reflect vehicles lent. At 825, the method 800 calculates, based on the data obtained from the fleet database updated to reflect vehicles lent, a number of available courtesy vehicle hours in a day by multiplying a number of courtesy vehicles in the fleet by 24 hours in the day. At 830, the method 800 determines, based on the data obtained from the fleet database updated to reflect vehicles lent, a number of actual used hours in which courtesy vehicles from the fleet were lent to customers on the day.

At 835, the method 800 calculates, based on the number of available courtesy vehicle hours and the number of actual used hours on the day, a usage percentage by dividing the number of actual used hours on the day by the number of available courtesy vehicle. At 840, the method 800 determines, based on the data obtained from the fleet database and the usage percentage, a number equivalent to actual courtesy vehicles used on the day by multiplying a total number of courtesy vehicles in the fleet by the usage percentage. At 845, the method 800 calculates, based on the number equivalent to actual courtesy vehicles used on the day, a number of waste or excess in vehicles for the day by calculating the difference between the total number of courtesy vehicles in the fleet and the number equivalent to actual courtesy vehicles used on the day. At 850, the method 800 calculates, based on the number of waste or excess in vehicles for the day, a running average of waste or excess vehicles in the fleet of courtesy vehicles. At 855, the method 800 outputs (e.g., on a periodic basis such as daily, weekly, monthly, etc.), based on the running average of waste or excess vehicles in the fleet of courtesy vehicles, a removal instruction to a worker at the dealership indicating that the running average of waste or excess vehicles in the fleet of courtesy vehicles is to be removed from the fleet of courtesy vehicles.

While the figures illustrate various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed, and that lightweight processes, regular processes, threads, and other approaches could be employed. It is to be appreciated that other exemplary methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

FIG. 9 illustrates a block diagram of an exemplary machine or apparatus 900 for evaluating whether vehicles are to be added or removed from a fleet of courtesy vehicles at a dealership. The machine 900 includes a processor 43, a memory 904, and I/O Ports 910 operably connected by a bus 908.

In one example, the machine 900 may receive input signals including communication from the advisor devices 20 via, for example, I/O Ports 910 or I/O Interfaces 918. In that sense, the I/O Ports 910 or I/O Interfaces 918 are equivalent or play the role of the transceiver 42. The machine 900 may also include the processor 43, and the fleet database 44 and advisor database 46 of the central server 40. Thus, the advisor devices 20 or the central server 40 may be implemented in machine 900 as hardware, firmware, software, or a combination thereof and, thus, the machine 900 and its components may provide means for performing functions described and/or claimed herein as performed by the advisor devices 20 or the central server 40 and their constituent parts such as the transceiver 42, the processor 43, and the databases 44, 46.

The processor 43 can be a variety of various processors including dual microprocessor and other multi-processor architectures. The memory 904 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 906 may be operably connected to the machine 900 via, for example, an I/O Interfaces (e.g., card, device) 918 and an I/O Ports 910. The disk 906 can include, but is not limited to, devices like a magnetic disk drive, a solid-state disk drive, a floppy disk drive, a tape drive, a Zip drive, a flash memory card, or a memory stick. Furthermore, the disk 906 can include optical drives like a CD-ROM, a CD recordable drive (CD-R drive), a CD rewriteable drive (CD-RW drive), or a digital video ROM drive (DVD ROM). The memory 904 can store processes 914 or data 916, for example. The disk 906 or memory 904 can store an operating system that controls and allocates resources of the machine 900.

The bus 908 can be a single internal bus interconnect architecture or other bus or mesh architectures. While a single bus is illustrated, it is to be appreciated that machine 900 may communicate with various devices, logics, and peripherals using other busses that are not illustrated (e.g., PCIE, SATA, Infiniband, 1394, USB, Ethernet). The bus 908 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The machine 900 may interact with input/output devices via I/O Interfaces 918 and I/O Ports 910. Input/output devices can include, but are not limited to, a keyboard, a microphone, a pointing and selection device, cameras, video cards, displays, disk 906, network devices 920, and the like. The I/O Ports 910 can include but are not limited to, serial ports, parallel ports, and USB ports.

The machine 900 can operate in a network environment and thus may be connected to network devices 920 via the I/O Interfaces 918, or the I/O Ports 910. Through the network devices 920, the machine 900 may interact with a network. Through the network, the machine 900 may be logically connected to remote computers. The networks with which the machine 900 may interact include, but are not limited to, a local area network (LAN), a wide area network (WAN), and other networks. The network devices 920 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 920 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

“Data store” or “database,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software or combinations of each to perform a function(s) or an action(s), or to cause a function or action from another logic, method, or system. For example, based on a desired application or needs, logic may include a software-controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted, or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servlet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User” or “consumer,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

1. An apparatus or group of apparatuses forming a system for evaluating whether vehicles are to be added or removed from a fleet of courtesy vehicles at a dealership, the system comprising:
a fleet database configured to store data associated with vehicles forming part of the fleet of courtesy vehicles at the dealership;
at least one computing device including a programmable processor operably coupled to the fleet database and configured to:
detect at least one of lending or returning of at least one vehicle from the fleet of courtesy vehicles;
update, in response to the detected at least one of lending or returning of the at least one vehicle from the fleet of courtesy vehicles, the fleet database for the data to reflect vehicles lent;
determine, based on the data obtained from the fleet database updated to reflect vehicles lent, a daily number of vehicles lent;
calculate, in response to the determining the daily number of vehicles lent, a difference between a number of vehicles in the fleet of courtesy vehicles and the daily number of vehicles lent to determine a number of excess vehicles in the fleet of courtesy vehicles; and
output, in response to the calculating the difference between the number of vehicles in the fleet of courtesy vehicles and the daily number of vehicles lent to determine the number of excess vehicles in the fleet of courtesy vehicles, a removal instruction to a worker at the dealership indicating that the number of excess vehicles in the fleet of courtesy vehicles is to be removed from the fleet of courtesy vehicles.

2. The system of claim 1, the processor configured to:
detect removal of at least one vehicle from the fleet of courtesy vehicles; and
update, in response to the detected removal of the at least one vehicle from the fleet of courtesy vehicles, the fleet database for the data to reflect the number of vehicles in the fleet of courtesy vehicles.

3. The system of claim 1, the processor configured to:
calculate, in response to the determining the daily number of vehicles lent, the difference between the number of vehicles in the fleet of courtesy vehicles and the daily number of vehicles lent to determine a shortage number of vehicles in the fleet of courtesy vehicles; and
output, in response to the calculating the difference between the number of vehicles in the fleet of courtesy vehicles and the daily number of vehicles lent to determine the shortage number of vehicles in the fleet of courtesy vehicles, an addition instruction to a worker at the dealership indicating that the number of shortage vehicles in the fleet of courtesy vehicles is to be added to the fleet of courtesy vehicles.

4. The system of claim 1, the processor configured to:
calculate, in response to the determining the daily number of vehicles lent, the difference between the number of vehicles in the fleet of courtesy vehicles and the daily number of vehicles lent to determine a shortage number of vehicles in the fleet of courtesy vehicles;
output, in response to the calculating the difference between the number of vehicles in the fleet of courtesy vehicles and the daily number of vehicles lent to determine the shortage number of vehicles in the fleet of courtesy vehicles, an addition instruction to a worker at the dealership indicating that the number of shortage vehicles in the fleet of courtesy vehicles is to be added to the fleet of courtesy vehicles;
detect addition of at least one vehicle to the fleet of courtesy vehicles; and
update, in response to the detected addition of the at least one vehicle to the fleet of courtesy vehicles, the fleet database for the data to reflect the number of vehicles in the fleet of courtesy vehicles.

5. The system of claim 1, comprising:
an advisor database configured to store data associated with advisors who lend to customers vehicles forming part of the fleet of courtesy vehicles;
the programmable processor operably coupled to the advisor database and configured to: detect at least one of:
number of vehicles lent by each advisor;
number of vehicles lent by each advisor by pay type, where pay types include customer pay, dealership pay, warranty, and recall; and
days a return of a vehicle from the fleet of courtesy vehicles is past due.

6. The system of claim 1, the processor configured to:
calculate, based on the data obtained from the fleet database updated to reflect the vehicles lent, a lending rate for each vehicle from the fleet of courtesy vehicles;
determine, in response to the calculating the lending rate for each vehicle from the fleet of courtesy vehicles, at least one vehicle from the fleet of courtesy vehicles whose lending rate is lower than a predetermined lending rate; and
output, in response to the determining the at least one vehicle from the fleet of courtesy vehicles whose lending rate is lower than the predetermined lending rate, an inspection instruction to a worker at the dealership indicating that the at least one vehicle from the fleet of courtesy vehicles whose lending rate is lower than the predetermined lending rate is to be inspected.

7. The system of claim 1, the processor configured to:
calculate, based on the data obtained from the fleet database including at least one of vehicle mileage and vehicle age, a depreciation amount for each vehicle in the fleet of courtesy vehicles;
calculate, based on a purchase price for each vehicle in the fleet of courtesy vehicles and the depreciation amount for each vehicle in the fleet of courtesy vehicles, an estimated current value for each vehicle in the fleet of courtesy vehicles;
calculate, based on the estimated current value for each vehicle in the fleet of courtesy vehicles and a published value for each vehicle in the fleet of courtesy vehicles, an estimated profit for each vehicle in the fleet of courtesy vehicles; and
output, in response to the calculating the estimated profit for each vehicle in the fleet of courtesy vehicles, a removal instruction to a worker at the dealership indicating that at least one vehicle from the fleet of courtesy vehicles is to be removed from the fleet of courtesy vehicles to be sold for a profit.

9. A method for evaluating whether vehicles are to be added or removed from a fleet of courtesy vehicles at a dealership, the method comprising:
providing a fleet database configured to store data associated with vehicles forming part of the fleet of courtesy vehicles;
providing at least one computing device including a programmable processor coupled to the fleet database;
detecting, via the at least one computing device, at least one of lending or returning of at least one vehicle from the fleet of courtesy vehicles;
updating, via the at least one computing device and in response to the detected at least one of lending or returning of the at least one vehicle from the fleet of courtesy vehicles, the fleet database for the data to reflect vehicles lent;
determining, via the at least one computing device and based on the data obtained from the fleet database updated to reflect vehicles lent, a daily number of vehicles lent;
calculating, via the at least one computing device and in response to the determining the daily number of vehicles lent, a difference between a number of vehicles in the fleet of courtesy vehicles and the daily number of vehicles lent to determine a number of excess vehicles in the fleet of courtesy vehicles; and
outputting, via the at least one computing device and in response to the calculating the difference between the number of vehicles in the fleet of courtesy vehicles and the daily number of vehicles lent to determine the number of excess vehicles in the fleet of courtesy vehicles, a removal instruction to a worker at the dealership indicating that the number of excess vehicles in the fleet of courtesy vehicles is to be removed from the fleet of courtesy vehicles.

10. The method of claim 9, comprising:
detecting, via the at least one computing device, removal of at least one vehicle from the fleet of courtesy vehicles; and
updating, via the at least one computing device and in response to the detected removal of the at least one vehicle from the fleet of courtesy vehicles, the fleet database for the data to reflect the number of vehicles in the fleet of courtesy vehicles.

11. The method of claim 9, comprising:
calculating, via the at least one computing device and in response to the determining the daily number of vehicles lent, the difference between the number of vehicles in the fleet of courtesy vehicles and the daily number of vehicles lent to determine a shortage number of vehicles in the fleet of courtesy vehicles; and
outputting, via the at least one computing device and in response to the calculating the difference between the number of vehicles in the fleet of courtesy vehicles and the daily number of vehicles lent to determine the shortage number of vehicles in the fleet of courtesy vehicles, an addition instruction to a worker at the dealership indicating that the number of shortage vehicles in the fleet of courtesy vehicles is to be added to the fleet of courtesy vehicles.

12. The method of claim 9, comprising:
calculating, via the at least one computing device and in response to the determining the daily number of vehicles lent, the difference between the number of vehicles in the fleet of courtesy vehicles and the daily number of vehicles lent to determine a shortage number of vehicles in the fleet of courtesy vehicles;
outputting, via the at least one computing device and in response to the calculating the difference between the number of vehicles in the fleet of courtesy vehicles and the daily number of vehicles lent to determine the shortage number of vehicles in the fleet of courtesy vehicles, an addition instruction to a worker at the dealership indicating that the number of shortage vehicles in the fleet of courtesy vehicles is to be added to the fleet of courtesy vehicles;
detecting, via the at least one computing device, addition of at least one vehicle to the fleet of courtesy vehicles; and
updating, via the at least one computing device and in response to the detected addition of the at least one vehicle to the fleet of courtesy vehicles, the fleet database for the data to reflect the number of vehicles in the fleet of courtesy vehicles.

13. The method of claim 9, comprising:
providing an advisor database configured to store data associated with advisors who lend to customers vehicles forming part of the fleet of courtesy vehicles, the programmable processor coupled to the advisor database;
detecting, via the at least one computing device, at least one of:
number of vehicles lent by each advisor;
number of vehicles lent by each advisor by pay type, where pay types include customer pay, dealership pay, warranty, and recall; and
days a return of a vehicle from the fleet of courtesy vehicles is past due.

14. The method of claim 9, comprising:
calculating, via the at least one computing device and based on the data obtained from the fleet database updated to reflect the vehicles lent, a lending rate for each vehicle from the fleet of courtesy vehicles;
determining, via the at least one computing device and in response to the calculating the lending rate for each vehicle from the fleet of courtesy vehicles, at least one vehicle from the fleet of courtesy vehicles whose lending rate is lower than a predetermined lending rate; and
outputting, via the at least one computing device and in response to the determining the at least one vehicle from the fleet of courtesy vehicles whose lending rate is lower than the predetermined lending rate, an inspection instruction to a worker at the dealership indicating that the at least one vehicle from the fleet of courtesy vehicles whose lending rate is lower than the predetermined lending rate is to be inspected.

15. The method of claim 9, comprising:
calculating, via the at least one computing device and based on the data obtained from the fleet database including at least one of vehicle mileage and vehicle age, a depreciation amount for each vehicle in the fleet of courtesy vehicles;
calculating, via the at least one computing device and based on a purchase price for each vehicle in the fleet of courtesy vehicles and the depreciation amount for each vehicle in the fleet of courtesy vehicles, an estimated current value for each vehicle in the fleet of courtesy vehicles;
calculating, via the at least one computing device and based on the estimated current value for each vehicle in the fleet of courtesy vehicles and a published value for each vehicle in the fleet of courtesy vehicles, an estimated profit for each vehicle in the fleet of courtesy vehicles; and
outputting, via the at least one computing device and in response to the calculating the estimated profit for each vehicle in the fleet of courtesy vehicles, a removal instruction to a worker at the dealership indicating that at least one vehicle from the fleet of courtesy vehicles is to be removed from the fleet of courtesy vehicles to be sold for a profit.

16. The method of claim 9, comprising:
calculating, via the at least one computing device and in response to the determining the daily number of vehicles lent, a running average of vehicles lent and a difference between the number of vehicles in the fleet of courtesy vehicles and the running average of vehicles lent to determine the number of excess vehicles in the fleet of courtesy vehicles; and
outputting, via the at least one computing device and in response to the calculating the difference between the number of vehicles in the fleet of courtesy vehicles and the running average of vehicles lent to determine the number of excess vehicles in the fleet of courtesy vehicles, a removal instruction to a worker at the dealership indicating that the number of excess vehicles in the fleet of courtesy vehicles is to be removed from the fleet of courtesy vehicles.

17. An apparatus or group of apparatuses forming a system for evaluating whether vehicles are to be added or removed from a fleet of courtesy vehicles at a dealership, the system comprising:
a receiver communicatively coupled to a fleet database and configured to receive from the fleet database data associated with vehicles forming part of the fleet of courtesy vehicles at the dealership;
a control unit including a programmable processor operably coupled to the receiver and configured to:
detect at least one of lending or returning of at least one vehicle;
update, in response to the detected at least one of lending or returning of the at least one vehicle, the fleet database for the data to reflect vehicles lent;
calculate, based on the data obtained from the fleet database updated to reflect vehicles lent, a number of available courtesy vehicle hours in a day by multiplying a number of courtesy vehicles in the fleet by 24 hours in the day;
determine, based on the data obtained from the fleet database updated to reflect vehicles lent, a number of actual used hours in which courtesy vehicles from the fleet were lent to customers on the day;
calculate, based on the number of available courtesy vehicle hours and the number of actual used hours on the day, a user percentage by dividing the number of actual used hours on the day by the number of available courtesy vehicle;
determine, based on the data obtained from the fleet database and the user percentage, a number equivalent to actual courtesy vehicles used on the day by multiplying a total number of courtesy vehicles in the fleet by the usage percentage;
calculate, based on the number equivalent to actual courtesy vehicles used on the day, a number of waste or excess in vehicles for the day by calculating the difference between the total number of courtesy vehicles in the fleet and the number equivalent to actual courtesy vehicles used on the day; and
output, in response to the calculating the number of waste or excess vehicles in the fleet of courtesy vehicles, a removal instruction to a worker at the dealership indicating that the number of waste or excess vehicles in the fleet of courtesy vehicles is to be removed from the fleet of courtesy vehicles.

18. The apparatus or group of apparatuses of claim 17, the programmable processor configured to:
calculate, based on the number of waste or excess in vehicles for the day, a running average of waste or excess vehicles in the fleet of courtesy vehicles; and
output, in response to the calculating the running average of waste or excess vehicles in the fleet of courtesy vehicles, a removal instruction to a worker at the dealership indicating that the running average of waste or excess vehicles in the fleet of courtesy vehicles is to be removed from the fleet of courtesy vehicles.

19. A method for evaluating whether vehicles are to be added or removed from a fleet of courtesy vehicles at a dealership, the system comprising:
providing a fleet database configured to store data associated with vehicles forming part of the fleet of courtesy vehicles;
providing at least one computing device including a programmable processor coupled to the fleet database;
detecting at least one of lending or returning of at least one vehicle;
updating, in response to the detected at least one of lending or returning of the at least one vehicle, the fleet database for the data to reflect vehicles lent;
calculating, based on the data obtained from the fleet database updated to reflect vehicles lent, a number of available courtesy vehicle hours in a day by multiplying a number of courtesy vehicles in the fleet by 24 hours in the day;
determining, based on the data obtained from the fleet database updated to reflect vehicles lent, a number of actual used hours in which courtesy vehicles from the fleet were lent to customers on the day;
calculating, based on the number of available courtesy vehicle hours and the number of actual used hours on the day, a user percentage by dividing the number of actual used hours on the day by the number of available courtesy vehicle;
determining, based on the data obtained from the fleet database and the user percentage, a number equivalent to actual courtesy vehicles used on the day by multiplying a total number of courtesy vehicles in the fleet by the usage percentage;
calculating, based on the number equivalent to actual courtesy vehicles used on the day, a number of waste or excess in vehicles for the day by calculating the difference between the total number of courtesy vehicles in the fleet and the number equivalent to actual courtesy vehicles used on the day; and
outputting, in response to the calculating the number of waste or excess vehicles in the fleet of courtesy vehicles, a removal instruction to a worker at the dealership indicating that the number of waste or excess vehicles in the fleet of courtesy vehicles is to be removed from the fleet of courtesy vehicles.

20. The method of claim 19, comprising:
calculating, based on the number of waste or excess in vehicles for the day, a running average of waste or excess vehicles in the fleet of courtesy vehicles; and
outputting, in response to the calculating the running average of waste or excess vehicles in the fleet of courtesy vehicles, a removal instruction to a worker at the dealership indicating that the running average of waste or excess vehicles in the fleet of courtesy vehicles is to be removed from the fleet of courtesy vehicles.
